(19) United States
(12) Patent Application Publication
(10) Pub. No.: US 2011/0290980 A1
(43) Pub. Date: Dec. 1, 2011

(54) COMPOSITE ENCAPSULATED ENGINE MOUNT

(76) Inventor: Jeff Bradshaw, Bloomfield, MI (US)

(21) Appl. No.: 13/143,711

(22) PCT Filed: Jan. 8, 2010
(86) PCT No.: PCT/US10/20437

§ 371 Date: Aug. 22, 2011

(30) Foreign Application Priority Data
Jan. 8, 2009 (US) 61/143176

(51) Int. Cl. F16M 13/00; F16C 33/24; B29C 45/14

(52) U.S. Cl. 248/674; 264/279; 264/277; 264/138; 264/266

(57) ABSTRACT

A composite encapsulated engine mount includes a rubber bushing having a metal shell received around the bushing. A plastic bracket having a cavity receives the bushing and shell therein. An associated method of forming the mount assembly includes inserting a bushing into a mold, introducing a moldable material into the mold around at least a portion of the bushing to form a bracket, and curing the bracket about the bushing.

### BACKGROUND OF THE DISCLOSURE

This application claims priority from U.S. Provisional Patent Application Ser. No. 61/143,176, filed 8 Jan. 2009, the disclosure of which is hereby expressly incorporated herein by reference.

This disclosure relates to an engine or torque reacting mount and a method of assembling the mount. Typically, engine mount brackets are made from cast iron, cast aluminum, or stamped steel. A separately made, bushing or roll restrictor is pressed into an opening or cavity in the cast or stamped bracket. The opening is sufficiently smaller so that substantial force is required to press the bushing into the opening.

More recently, composite plastic brackets have been proposed. The mount assembly still incorporates a rubber bushing in the composite bracket. There are two known ways in which the pre-molded rubber bushing is joined to the composite bracket. In the first arrangement, the bushing is pressed into the composite bracket in a manner similar to the pre-molded rubber bushing being pressed into a cast or stamped bracket. In the second arrangement, the rubber bushing is molded into the composite bracket. That is, the composite bracket is original pre-molded or pre-manufactured and then the rubber bushing is molded in-situ (molded within the opening) of the composite bracket.

These prior arrangements require the bushing to be pre-compressed or pressed with significant force into the bracket opening to insure retention of the bushing. Further, additional assembly steps and high tooling costs are associated with these arrangements. In the prior manner of molding the rubber bushing in the pre-manufactured bracket, tensile loads result as the rubber cures. Specifically, the tensile loads develop as a result of shrinkage of the rubber during the curing process.

Consequently, a need exists for reduced costs, reduced weight, reduced complexity, and to permit the use of a composite material bracket.

### SUMMARY OF THE DISCLOSURE

A new mount assembly, and a method of forming a mount assembly are disclosed.

The method of forming a mount assembly includes inserting a pre-molded or pre-manufactured bushing into a mold, introducing a moldable material around at least a portion of the bushing to form a bracket, and curing the bracket about the bushing which results in shrinkage of the bracket to retain the bushing.

In an exemplary embodiment, the moldable material is a composite or plastic material that is introduced into the mold.

The bushing inserting step includes retaining the bushing in a metal outer shell prior to introducing the moldable material around the bushing.

Curing of the moldable material reduces a cross-sectional dimension of the bushing upon shrinking, and thereby retains the bushing in the bracket.

The composite encapsulated engine mount preferably includes a rubber bushing received in a metal shell. The bushing and shell are together received in an opening of a plastic/composite bracket.

The outer shell and plastic bracket are mold bonded together.

A metal insert may be optionally provided in the rubber bushing, and strengthening inserts may be optionally incorporated in the plastic bracket at selected fastener receiving locations.

A primary advantage associated with the method of assembly and the resultant mount assembly is the reduced weight resulting from use of a composite or plastic bracket instead of a metal bracket.

Another advantage resides in the reduced cost of forming the rubber bushing because the bushing can be molded in a large number, multi-cavity mold rather than injecting rubber into cast or molded composite brackets that take up more room in the same size molding machine.

Cost is also reduced since there is no need to heat the bracket in advance for bonding purposes with the rubber bushing.

Reduced heating is also associated with the new process since elevated temperatures are no longer required to assure cross-linking of the rubber bushing.

Another advantage resides in the elimination of secondary operations of swaging or pressing a bushing into a bracket opening.

Still, other benefits and advantages of the present disclosure will become apparent to those skilled in the art upon reading and understanding the following, detailed description.

### BRIEF DESCRIPTION OF THE DRAWINGS

FIG. 1 is an exploded view of a prior art engine mount.

FIG. 2 is a perspective view of the assembled engine mount as known in the prior art.

FIG. 3 illustrates a pre-formed rubber bushing inserted into an outer shell.

FIG. 4 illustrates a multi-cavity mold.

FIG. 5 shows insertion of pre-formed rubber bushings into each of the mold cavities.

FIG. 6 shows composite brackets molded around a rubber bushing in each of the mold cavities.

FIG. 7 is an enlarged plan view of a completed engine mount.

### DETAILED DESCRIPTION OF THE PREFERRED EMBODIMENT

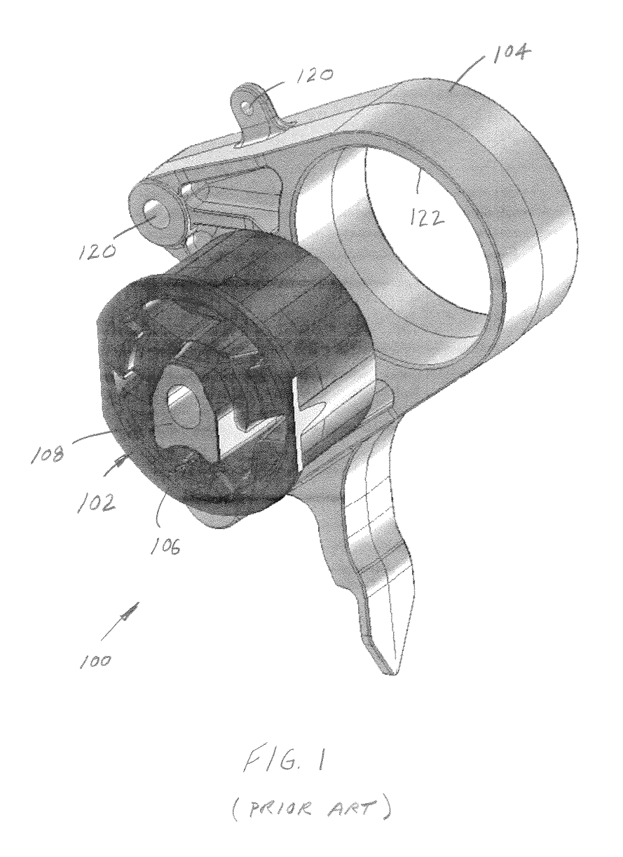

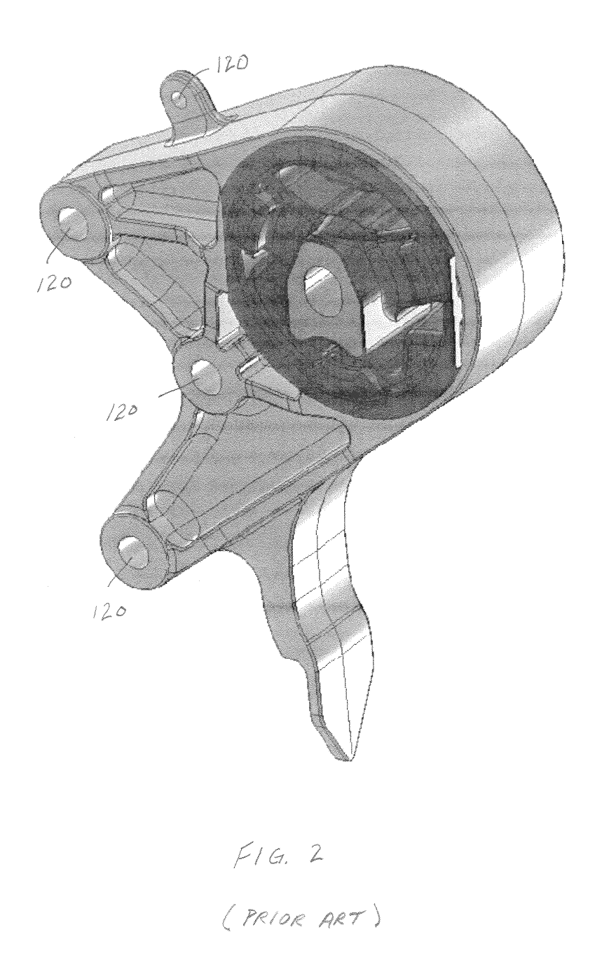

Turning initially to FIGS. 1 and 2, a torque reacting or engine mount (hereinafter referred to as a mount or engine mount) assembly 100 includes a roll restrictor or bushing (generally referred to as a bushing) 102 received in an outer bracket 104. In a prior arrangement, bushing 102 is typically formed of rubber 106 and may include an insert such as metal insert 108. In this particular embodiment, the metal insert 108 is centrally located in the rubber of the bushing 106. Moreover, the bushing may include one or more cavities at select locations that provide desired areas of relative movement and force damping in a manner well-known in the art.

The bracket 104 is configured for receipt in an associated vehicle and includes one or more fastener receiving openings 120 that receive an associated fastener (not shown) and secure the bracket/engine mount assembly to the vehicle. An opening 122 in the bracket is dimensioned to receive the rubber bushing 102. Typically, the opening 122 is sufficiently smaller than the outer dimension or diameter of the rubber bushing so that the bushing must be compressed (i.e., reduced in cross-sectional dimension) in order to be received in the bracket opening. A substantial force is required to insert the rubber bushing into the bracket opening, however, this force also serves to mechanically retain the bushing or roll restrictor in place in the bracket. Typically the bracket is cast iron, cast aluminum, or stamped steel construction, although in some instances it has been suggested that the bracket could be formed from a composite or plastic material having sufficient strength to receive the rubber bushing and satisfy the requirements of the engine mount environment.

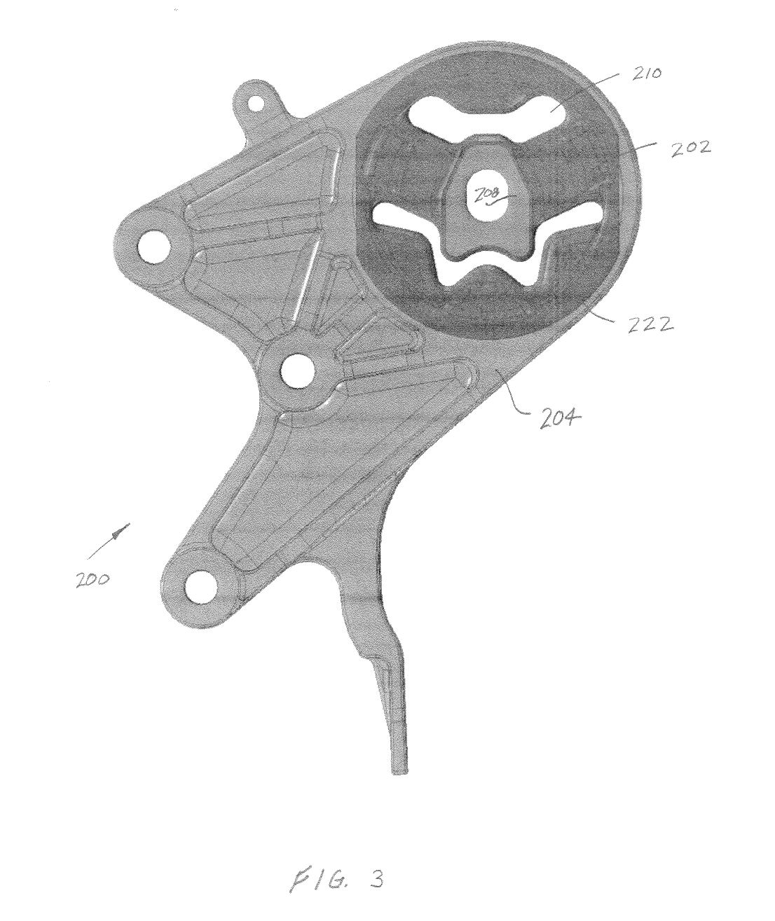

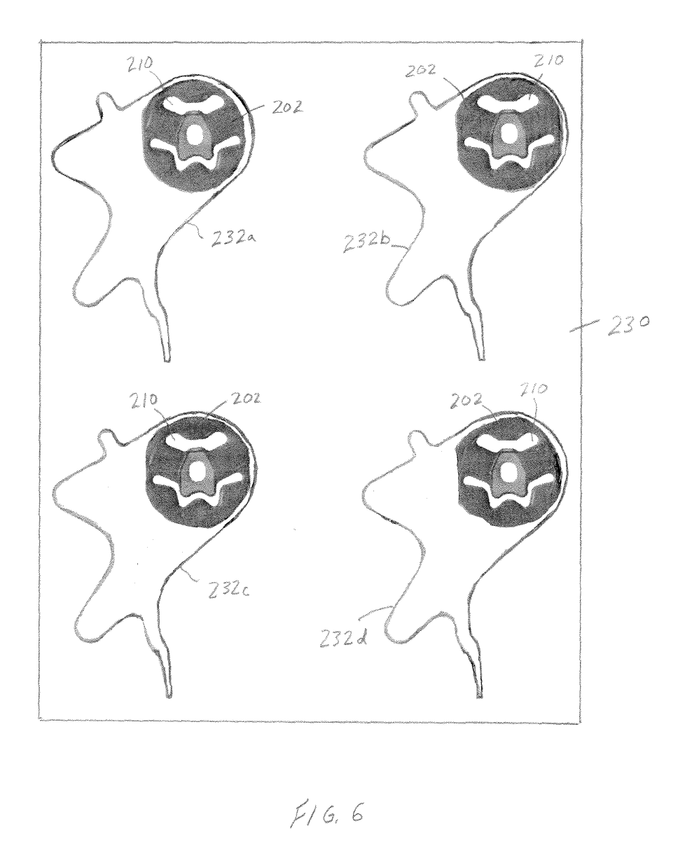

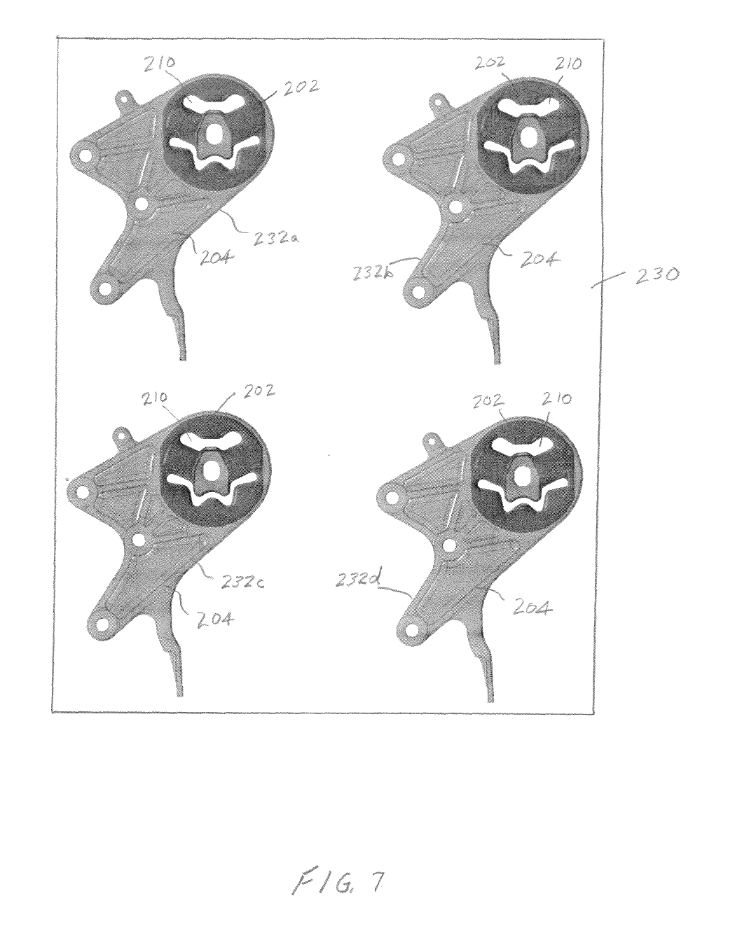

Shown in FIGS. 3-7, is an engine mount assembly 200 that includes a bushing 202 that is received in a composite or plastic bracket 204. Again, the bushing 202 is primarily a rubber bushing 206 that typically includes an insert such as metal insert 208 shown here as extending through a central portion of the bushing. One or more cavities 210 are provided in the bushing to permit selective deflection and also serve to damp forces imposed on the engine mount.

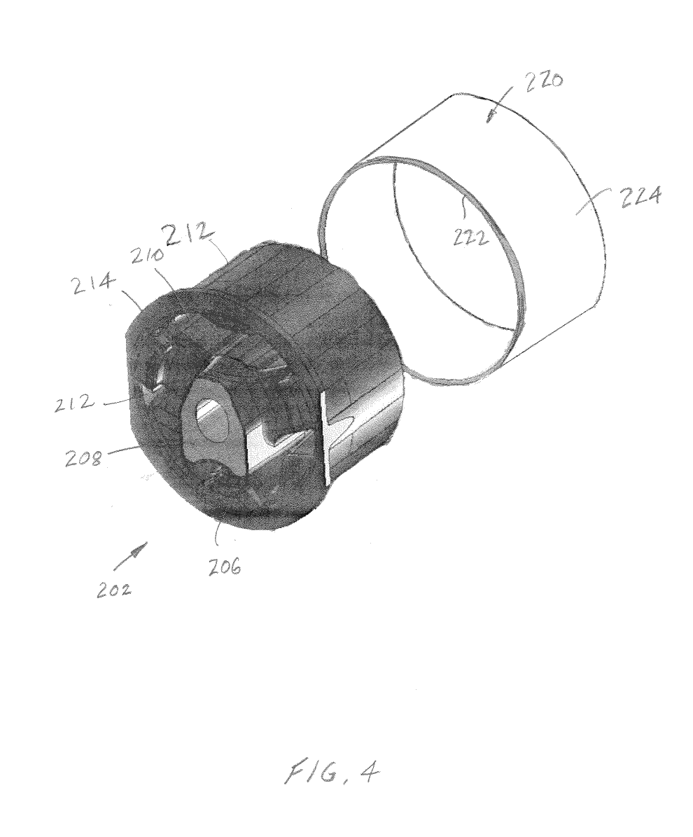

The bushing is pre-molded, pre-formed, or pre-manufactured in the embodiment of FIGS. 3-7. The bushing 202 may have a variety of configurations, and in the illustrated arrangement has a generally cylindrical outer conformation 212 (FIG. 4) along a major portion thereof, and an outer perimeter flange 214 adjacent one end for reasons to be identified below. An outer shell or ring 220 is dimensioned to receive at least a portion of the rubber bushing in a central opening 222 of the outer shell. The opening 222 is dimensioned so that the bushing is molded therein, or so that only a small force is required for inserting the rubber bushing into the metal outer shell 220. Engagement between the flange 214 of the bushing with an end of the outer shell 220 limits further axial advancement of the bushing into the outer shell if the bushing is separately molded from the outer shell and subsequently inserted. If desired, once the rubber bushing has been inserted or molded into the outer shell 220, the shell may be reduced in size to, in turn, reduce the outer dimension of the rubber, i.e. add a desired pre-stress into the bushing. Of course in other instances, the outer shell is not swaged or compressed.

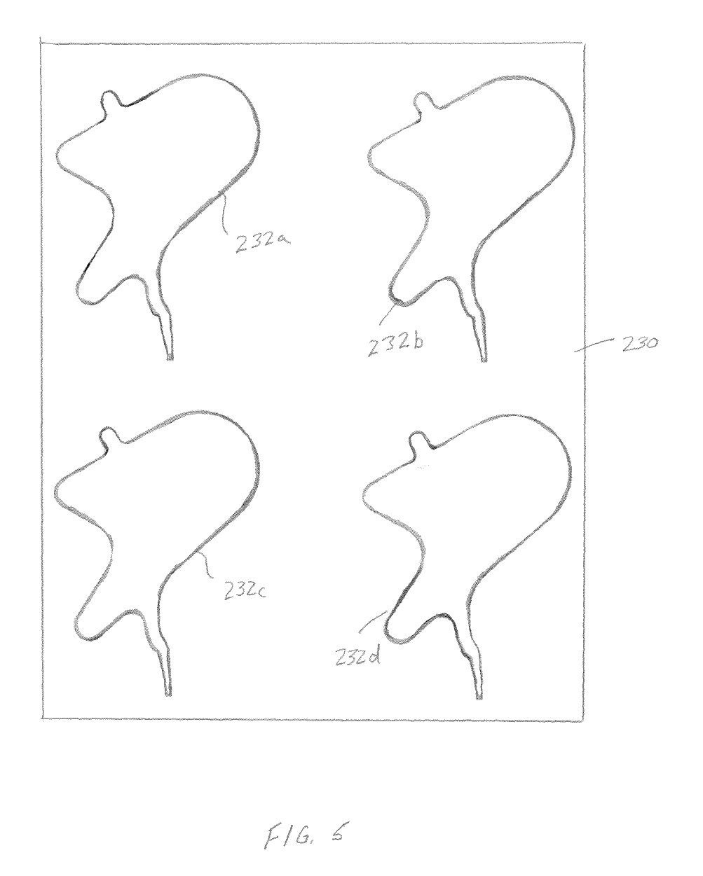

The subassembly of the bushing in the outer shell is placed into a mold 230, the mold of FIGS. 5-7 having multiple identical cavities 232 each dimensioned to preferably receive a bushing and outer shell subassembly therein. The particular number of cavities 232 (232a-232d) in the mold 230 may vary, and should not otherwise be deemed to limit the present disclosure. As will be appreciated, the conformation of each of the mold cavities 232 is preferably the same as the final desired configuration of the bracket of the engine mount assembly 200. The depth of each cavity 232 accommodates the bushing and surrounding outer shell, and the inner perimeter of the cavity forms the outline of the bracket as will be understood by one skilled in the art.

By using the outer shell, the composite or plastic material that is subsequently introduced into the cavity around the bushing subassembly will adhere to the metal of the outer shell, or to a binding material applied to the outer surface 224 of the shell to enhance the bond between the bushing subassembly and the bracket. The remainder of the surface of the mold cavity will conform to that required for the bracket. That is, in certain locations the mold surface will form ribs or depressed areas in the surface of the bracket in order to minimize the amount of moldable material (e.g., a composite or plastic that may optionally include a strengthening material such as nylon or polyphthalamide (PTA) or still another material) used in the final engine mount assembly.

Because the bushing is pre-formed, the temperature of the mold is selected to efficiently cure the plastic bracket, and need not be at an elevated temperature that might otherwise be required to cross link the rubber. The outer shell also need not be preheated since the metal material or use of a bonding material applied to the outer surface of the shell will be sufficient to create an effective bond therebetween.

Curing of the plastic/composite bracket results in shrinkage that advantageously serves to encapsulate and retain the bushing in the bracket. Further, shrinkage design considerations assure that the rubber subassembly is placed in compression if so desired.

This disclosure differs from prior designs by placing the pre-molded rubber bushing into the bracket mold and molding the plastic composite around the bushing. This method reduces the number of steps required to assemble a typical engine mount, and reduces the rubber mold complexity compared to the method of molding the rubber bushing into the composite bracket. The disclosure can be used on any bushing style engine mount or torque reacting mount where loads and temperatures permit the use of a composite material. This disclosure also reduces the weight of the final assembly, reduces the cost of the final assembly, and reduces the complexity of the mount assembly. The composite plastic bracket molded around the engine mount or torque reacting bushing shrinks and retains the bushing as the bushing cools and shrinks to retain the bushing in the bracket. Other methods of retaining the bushing in the bracket either require the bushing to be pre-compressed or pressed with significant force into the bracket to insure retention of the bushing—requiring either additional assembly steps and/or higher tooling costs. In order for the rubber bushing to be over molded with plastic composite, the bushing must be retained in a hard outer shell. This shell is usually made from either another plastic or metal. This will allow the plastic mold to ‘bite-off’ on the outer shell preventing the plastic from compressing the rubber during the plastic injection process. As the plastic composite bracket cools in the mold, the bracket shrinks around the bushing, thereby retaining the bushing in the bracket.

The disclosure has been described with reference to the preferred embodiment. Modifications and alterations will occur to others upon reading and understanding this specification. It is intended to include all such modifications and alterations in so far as they come within the scope of the appended claims or the equivalents thereof.

Having thus described the invention, we claim:

1. A method of forming a mount assembly comprising:
inserting a bushing into a mold;
introducing a moldable material into the mold around at least a portion of the bushing to form a bracket; and
curing the bracket about the bushing.

2. The method of claim 1 wherein the introducing step includes injecting the moldable material into the mold under pressure.

3. The method of claim 1 wherein the introducing step includes using a plastic material as the moldable material.

4. The method of claim 3 wherein the introducing step includes using a composite plastic material as the moldable material.

5. The method of claim 1 inserting step includes providing a preformed rubber bushing.

6. The method of claim 5 wherein the providing step includes retaining the rubber bushing in a metal outer shell prior to introducing the moldable material.

7. The method of claim 6 wherein the retaining step includes enclosing the rubber bushing in the outer shell prior to the bushing inserting step.

8. The method of claim 6 further comprising relieving internal stress in the rubber bushing.

9. The method of claim 8 wherein the relieving step occurs prior to the bushing inserting step.

10. The method of claim 8 wherein the relieving step includes reducing a cross-sectional dimension of the rubber bushing.

11. The method of claim 8 wherein the relieving step includes reducing a cross-section of the outer shell.

12. A composite encapsulated engine mount comprising:
a rubber bushing;
a metal shell received around the bushing; and
a plastic bracket having a cavity that receives the bushing and shell therein.

13. The mount of claim 12 wherein the shell and the plastic bracket are mold bonded together.

14. The mount of claim 12 further comprising a metal insert in the rubber bushing.

15. The mount of claim 12 further comprising strengthening inserts in the plastic bracket located only at fastener receiving locations.

16. The mount of claim 12 wherein the plastic bracket is a composite material that includes strengthening material interspersed throughout the bracket.

17. A method of retaining a rubber mount in a bracket comprising:
inserting a preformed rubber mount having an outer shell of a different material than rubber into a mold cavity;
introducing a fluid plastic material into the cavity in at least partially surrounding relation to the rubber mount; and
at least partially curing the plastic material around the outer shell and rubber mount to shrink and retain the outer shell and rubber mount therein.

18. The method of claim 17 further comprising compressing the rubber mount by changing the cross-sectional dimension of the outer shell prior to the inserting step.

19. The method of claim 17 wherein the outer shell is metal and the compressing step includes positioning the rubber mount in the outer shell and subsequently reducing the cross-sectional dimension of the outer shell.

20. The method of claim 19 wherein the reducing step results from shrinkage during cooling of the plastic.
